(19) United States
(12) Patent Application Publication
(10) Pub. No.: US 2015/0188119 A1
(43) Pub. Date: Jul. 2, 2015

(54) Safety Device Of Lithium-Ion Battery

(71) Applicant: Ningde Contemporary Amperex Technology Limited, Ningde (CN)

(72) Inventors: Hui Gao, Ningde (CN); Qiong Qu, Ningde (CN); Peng Wang, Ningde (CN); Pinghua Deng, Ningde (CN)

(21) Appl. No.: 14/562,511

(22) Filed: Dec. 5, 2014

(30) Foreign Application Priority Data
Dec. 31, 2013 (CN) 201320886713.3

(51) Int. Cl. H01M 2/34; H01M 2/04; H01M 2/12

(52) U.S. Cl. CPC H01M 2/345; H01M 2/1241; H01M 2/043; H01M 2200/20; H01M 2220/20

(57) ABSTRACT

A safety device of lithium-ion battery is provided which comprises a cap plate, a first electrode post, a second electrode post, a vent, a deformable plate, an insulating plate and a conductive plate, the first electrode post, the second electrode post and the vent are provided on the cap plate, the first electrode post and the cap plate are electrically connected, the first electrode post and the conductive plate are assembled in an insulating manner, the deformable plate is provided between the first electrode post and the conductive plate, the deformable plate are electrically connected to the first electrode post and the conductive plate, the deformable plate comprises a recessing portion, connecting portions and welding portions, the recessing portion is integrally connected to the welding portion by the connecting portion, the conductive plate is provided with a gas-guide hole, an opening of the gas-guide hole corresponds to the connecting portion.

### CROSS-REFERENCE TO RELATED APPLICATIONS

The present application claims priority to Chinese patent application No. 201320886713.3 filed on Dec. 31, 2013, which is incorporated herein by reference in its entirety.

### TECHNICAL FIELD OF THE PRESENT DISCLOSURE

The present disclosure belongs to the technical field of lithium-ion batteries, particularly relates to a safety device of lithium-ion battery.

### BACKGROUND OF THE PRESENT DISCLOSURE

With the development of modern society and people's awareness of environmental protection, electric vehicles are more inclined to use lithium-ion batteries as their energy sources. A power battery should not only have a high capacity, but should also have good safety and a long cycle life. In order to ensure the safety of the power battery to a certain extent, a vent is generally mounted on a cap plate of the power battery, when the power battery is involved in an accident caused by improper charging, short circuit or being exposed to a high temperature and other severe environments, the power battery with high energy will produce a large amount of gas and the temperature inside the power battery rises sharply, the gas bursts through the vent to achieve the pressure relief purpose. The presence of the vent can improve the safety performance of the power battery to some extent, but because the energy gathered by the battery itself which is involved in the accident is not released, the power battery itself is a potential dangerous resource, and there are some safety problems, if the power battery continues to be overcharged after involving the accident, more serious safety accidents will be caused.

### SUMMARY OF THE PRESENT DISCLOSURE

In view of the deficiencies in the existing technology, an object of the present disclosure is to provide a safety device of lithium-ion battery, when the lithium-ion battery is involved in an overcharge accident, the safety device can disconnect the charging circuit, and stop charging the lithium-ion battery, so as to improve the overcharge safety.

In order to achieve the above object, the present disclosure provides a safety device of lithium-ion battery which comprises a cap plate, a first electrode post, a second electrode post, a vent, a deformable plate, an insulating plate and a conductive plate, the first electrode post, the second electrode post and the vent are provided on the cap plate, the first electrode post and the cap plate are electrically connected, and the first electrode post and the conductive plate are assembled in an insulating manner, the deformable plate is provided between the first electrode post and the conductive plate, and the deformable plate are electrically connected to the first electrode post and the conductive plate, the deformable plate comprises a recessing portion, connecting portions and welding portions, the recessing portion is integrally connected to the welding portion by the connecting portion, the conductive plate is provided with a gas-guide hole, an opening of the gas-guide hole corresponds to the connecting portion.

In an embodiment of the safety device of lithium-ion battery of the present disclosure, the safety device of lithium-ion battery further comprises an injection-molded piece, the injection-molded piece and the insulating plate are provided on the cap plate, and the insulating plate is positioned between the first electrode post and the deformable plate, the injection-molded piece and the insulating plate each are provided with a gas-guide channel, the two the gas-guide channels are respectively communicated to the connecting portions.

In an embodiment of the safety device of lithium-ion battery of the present disclosure, the first electrode post is electrically connected to the cap plate by welding or riveting.

In an embodiment of the safety device of lithium-ion battery of the present disclosure, the first electrode post is provided with an exhaust hole and a step hole communicated to the exhaust hole, the deformable plate is provided inside the step hole in a sealing manner.

In an embodiment of the safety device of lithium-ion battery of the present disclosure, the second electrode post and the cap plate are assembled in an insulating manner

In an embodiment of the safety device of lithium-ion battery of the present disclosure, a thickness of the connecting portion is smaller than a thickness of the welding portion.

In an embodiment of the safety device of lithium-ion battery of the present disclosure, the thickness of the connecting portion is 0.1 mm˜1 mm, the smaller the thickness is, the more sensitive the connecting portion senses changes of the internal gas pressure, and the lower the gas pressure required for displacing the deformable plate is; the thickness of the welding portion is 0.5 mm˜2 mm, it is ensured that the welding portion is not molten through when it is welded to the conductive plate by laser welding, so as to ensure the sealing performance of welding.

In an embodiment of the safety device of lithium-ion battery of the present disclosure, the thickness of the connecting portion is 0.3 mm˜0.4 mm, if the thickness of the connecting portion is too small, the deformable plate is very easily deformed; the thickness of the welding portion is 0.6 mm˜0.7 mm, if the thickness of the welding portion is too large, the welding portion takes up too much space, the volume density of the entire battery is affected.

In an embodiment of the safety device of lithium-ion battery of the present disclosure, the conductive plate is further provided with a welding hole, the recessing portion is provided inside the welding hole by laser welding in a sealing manner.

In an embodiment of the safety device of lithium-ion battery of the present disclosure, a shape of the cap plate is a rectangle, a circle or an ellipse.

The present disclosure has the following beneficial effects: the safety device of lithium-ion battery of the present disclosure comprises the cap plate, the first electrode post, the second electrode post, the vent, the deformable plate, the insulating plate and the conductive plate, the first electrode post, the second electrode post and the vent are provided on the cap plate, the first electrode post and the cap plate are electrically connected, and the first electrode post and the conductive plate are assembled in an insulating manner, the deformable plate is provided between the first electrode post and the conductive plate, and the deformable plate are electrically connected to the first electrode post and the conductive plate, the deformable plate comprises the recessing portion, the connecting portions and the welding portions, the recessing portion is integrally connected to the welding portion by the connecting portion, the conductive plate is provided with the gas-guide hole, the opening of the gas-guide hole corresponds to the connecting portion, which allows the connecting portion to sense changes of an internal gas pressure of a battery more sensitive, the deformable plate can be displaced even at a lower gas pressure, the welding portion can ensure that the deformable plate is not molten through at the moment of laser welding, thereby ensuring the sealing performance of welding. In conclusion, the deformable plate can be displaced instantly at a limited gas pressure, and electrically disconnected from the conductive plate. The safety device of lithium-ion battery of the present disclosure involved in an accident can stop charging by the safety device, so as to prevent safety hazards caused by overcharging the lithium-ion battery.

### BRIEF DESCRIPTION OF THE FIGURES

FIG. 1 is a schematic structural view of the present disclosure.

FIG. 2 is an enlarged view of the A portion of FIG. 1.

FIG. 3 is a schematic view of the present disclosure after the deformable plate is displaced.

FIG. 4 is a schematic structural view of a deformable plate of the present disclosure.

### DETAILED DESCRIPTION

Hereinafter the present disclosure will be described in detail in combination with specific embodiments and drawings, but the present disclosure is not limited to these embodiments.

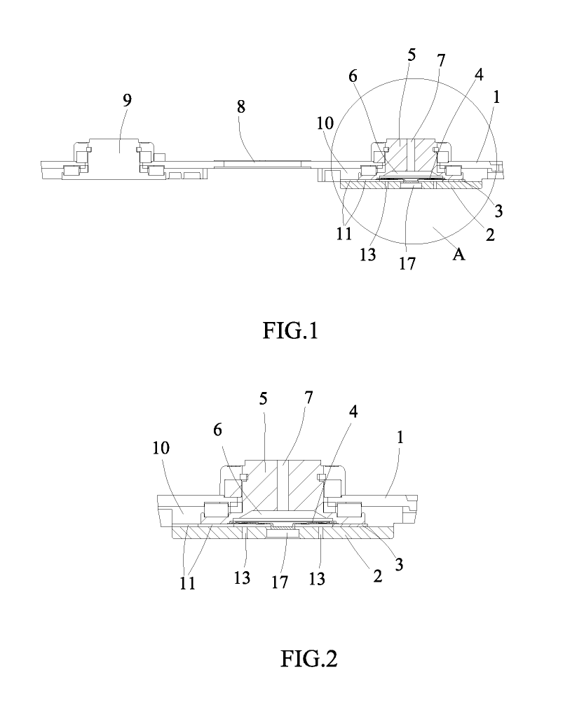

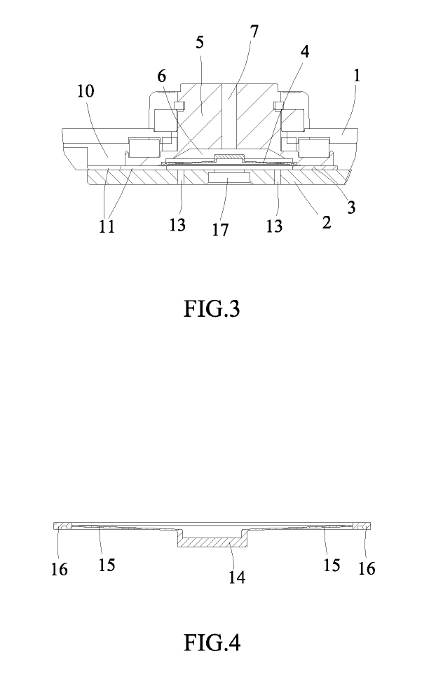

As shown in FIGS. 1-4, a safety device of lithium-ion battery comprises a cap plate 1, a first electrode post 5, a second electrode post 9, a vent 8, a deformable plate 4, an insulating plate 3 and a conductive plate 2. The first electrode post 5, the second electrode post 9 and the vent 8 are provided on the cap plate 1, a shape of the cap plate 1 is an ellipse, the cap plate 1 is made of aluminum or stainless steel, the first electrode post 5 and the cap plate 1 are electrically connected, and the first electrode post 5 and the conductive plate 2 are assembled in an insulating manner, the deformable plate 4 are provided between the first electrode post 5 and the conductive plate 2, and the deformable plate 4 is electrically connected to the first electrode post 5 and the conductive plate 2, the second electrode post 9 and the cap plate 1 are assembled in an insulating manner, the deformable plate 4 comprises a recessing portion 14, connecting portions 15 and welding portions 16, the recessing portion 14 is integrally connected to the welding portion 16 by the connecting portion 15, the conductive plate 2 is provided with a gas-guide hole 13, an opening of the gas-guide hole 13 corresponds to the connecting portion 15, the conductive plate 2 is further provided with a welding hole 17, the recessing portion 14 is provided inside the welding hole 17 by laser welding in a sealing manner. The welding portion 16, the connecting portion 15 and the recessing portion 14 are sequentially thinned and then thickened, which allows the connecting portion 15 to sense changes of an internal gas pressure of a battery more sensitive, the deformable plate 4 can be displaced even at a lower gas pressure, the welding portion 16 can ensure that the deformable plate 4 is not molten through at the moment of laser welding, thereby ensuring the sealing performance of welding. The deformable plate 4 can be displaced instantly at a limited gas pressure, and electrically disconnected from the conductive plate 2. The lithium-ion battery involved in an accident can stop charging by the safety device, so as to prevent safety hazards caused by overcharging the lithium-ion battery.

Preferably, the safety device further comprises an injection-molded piece 10, the injection-molded piece 10 and the insulating plate 3 are provided on the cap plate 1, and the insulating plate 3 is positioned between the first electrode post 5 and the deformable plate 4, the injection-molded piece 10 and the insulating plate 3 each provided with a gas-guide channel 11, the two gas-guide channels 11 are respectively communicated to the connecting portions 15, so that the internal gas pressure of the lithium-ion battery acts on the connecting portion 15 of the deformable plate 4 via the above two gas-guide channels 11, which assists the gas-guide hole 13 and together acts on the connecting portion 15, it is easier to achieve the displacing of the deformable plate 4, so as to further improve the safety of the lithium-ion battery.

Preferably, the first electrode post 5 is electrically connected to the cap plate 1 by welding, the first electrode post 5 is provided with an exhaust hole 7 and a step hole 6 communicated to the exhaust hole 7, the deformable plate 4 is provided inside the step hole 6 in a sealing manner.

A thickness of the connecting portion 15 is smaller than a thickness of the welding portion 16. The thickness of the connecting portion 15 is 0.5 mm, and the thickness of the welding portion 16 is 1 mm.

When the lithium-ion battery is involved in an accident, the internal gas pressure of the battery will rise, when the internal gas pressure reaches a displacing gas pressure of the deformable plate 4, the deformable plate 4 can be displaced instantly, and electrically disconnected from the conductive plate 2, thereby disconnecting the charging circuit and ensure the safety of the lithium-ion battery. The displacing gas pressure of the deformable plate 4 is 0.3 MPa˜0.5 MPa, and the deformable plate 4 is not broken at the gas pressure of 0.7 MPa, generally, a displacing height of the deformable plate 4 is not less than 0.5 mm.

It should be noted that, the thickness of the connecting portion 15 can also be any value from 0.1 mm to 1 mm other than 0.5 mm, the thickness of the welding portion 16 can also be any value from 0.5 mm to 2 mm other than 1 mm. The shape of the cap plate 1 can also be a rectangle or a circle. The first electrode post 5 can also be electrically connected to the cap plate 1 by riveting or a conducting element.

According to the foregoing descriptions and teachings of the present disclosure, appropriate variations and modifications of the above embodiments can occur to a person skilled in the art. Therefore, the present disclosure is not limited to the specific embodiments disclosed and described in the above, any obvious improvements, modifications and variations made based on the present disclosure by a person skilled in the art will also belong to the scope of the appended claims. Furthermore, although specific terminologies are used in the present disclosure, these terminologies are merely for convenience of description, and the present disclosure is not limited to that.

What is claimed is:

1. A safety device of lithium-ion battery comprising a cap plate, a first electrode post, a second electrode post, a vent, a deformable plate, an insulating plate and a conductive plate, the first electrode post, the second electrode post and the vent being provided on the cap plate, the first electrode post and the cap plate being electrically connected, and the first electrode post and the conductive plate being assembled in an insulating manner, the deformable plate being provided between the first electrode post and the conductive plate, and the deformable plate being electrically connected to the first electrode post and the conductive plate, the deformable plate comprising a recessing portion, connecting portions and welding portions, the recessing portion being integrally connected to the welding portion by the connecting portion, the conductive plate being provided with a gas-guide hole, an opening of the gas-guide hole corresponding to the connecting portion.

2. The safety device of lithium-ion battery according to claim 1, further comprising an injection-molded piece, the injection-molded piece and the insulating plate being provided on the cap plate, and the insulating plate being positioned between the first electrode post and the deformable plate, the injection-molded piece and the insulating plate each being provided with a gas-guide channel, the two the gas-guide channels being respectively communicated to the connecting portions.

3. The safety device of lithium-ion battery according to claim 1, wherein the first electrode post is electrically connected to the cap plate by welding or riveting.

4. The safety device of lithium-ion battery according to claim 3, wherein the first electrode post is provided with an exhaust hole and a step hole communicated to the exhaust hole, the deformable plate is provided inside the step hole in a sealing manner

5. The safety device of lithium-ion battery according to claim 1, wherein the second electrode post and the cap plate are assembled in an insulating manner

6. The safety device of lithium-ion battery according to claim 1, wherein a thickness of the connecting portion is smaller than a thickness of the welding portion.

7. The safety device of lithium-ion battery according to claim 6, wherein the thickness of the connecting portion is 0.1 mm˜1 mm, the thickness of the welding portion is 0.5˜2 mm.

8. The safety device of lithium-ion battery according to claim 7, wherein the thickness of the connecting portion is 0.3˜0.4 mm, the thickness of the welding portion is 0.6˜0.7 mm.

9. The safety device of lithium-ion battery according to claim 1, wherein the conductive plate is further provided with a welding hole, the recessing portion is provided inside the welding hole by laser welding in a sealing manner.

10. The safety device of lithium-ion battery according to claim 1, wherein a shape of the cap plate is a rectangle, a circle or an ellipse.
